(19) United States
(12) Patent Application Publication
(10) Pub. No.: US 2021/0337809 A1
(43) Pub. Date: Nov. 4, 2021

(54) COMPOSITIONS FOR IMPROVING AGRICULTURAL PRODUCTION

(71) Applicant: Environmental Services Pty Ltd, Thomastown (AU)

(72) Inventor: Kevin Joyce, Thomastown (AU)

(73) Assignee: Environmental Services Pty Ltd, Thomastown (AU)

(21) Appl. No.: 17/241,342

(22) Filed: Apr. 27, 2021

(30) Foreign Application Priority Data
Apr. 30, 2020 (AU) 2020901371

(51) Int. Cl. A01N 65/36; A01N 25/02; A01N 61/00; A01N 37/04; A01N 37/02; A01N 37/10; A01N 59/00; A01N 43/08; C05G 5/20; C05F 11/02; C05G 3/70; C05G 3/60

(52) U.S. Cl. CPC A01N 65/36; A01N 25/02; A01N 61/00; A01N 37/04; A01N 37/02; C05G 3/60; A01N 59/00; A01N 43/08; C05G 5/20; C05F 11/02; C05G 3/70; A01N 37/10

(57) ABSTRACT

According to the present invention there is provided a composition for treating plants seeds and soils for improvement of soil microbiology populations to facilitate enhanced plant growth wherein the composition comprises at least one bioflavonoid and at least one organic acid. Preferably, the composition includes at least one wetting agent. More preferably, the at least one wetting agent is a natural plant extract. The at least one bioflavonoid may be a natural plant extract. Further, the organic acid may be a naturally produced organic acid.

### FIELD OF THE INVENTION

This invention relates to compositions for improvement of agricultural production and more particularly relates to compositions for enhancing increasing soil health including increasing soil microbial populations.

### BACKGROUND

With an ever increasing population and stresses of climate change, there is pressure to increase agricultural production for purposes including food, animal fodder and fuel.

Traditional agricultural treatments such as tilling, harrowing, applying pesticides, herbicides or nutrients such as fertilizers have been responsible for a worldwide degradation of soil quality. Pesticides, herbicides or nutrients such as fertilizers have also been found to have undesirable side-effects on those ingesting them. Thus, there is also pressure to seek less harmful alternatives from consumers due to the growing public awareness of the effects of prolonged exposure or use of chemicals.

Further, synthetic chemicals such as fungicides, herbicides and fertilizers can have a negative effect on soil microbial population which reduce plant crop productivity. These chemicals also chelate (bind up) soil nutrients so they are not accessible by the plant. Only soil biology can release them. Without diverse soil biology there is a high vulnerability for the plants to disease pressure. Also soil biology is responsible for carbon holding capacity in the soil which directly correlates to water holding capacity.

The traditional agricultural treatments, together with other farming methods such as tilling and environment stress from climate change due to environment extremes, have been found to cause stress on the soils which consequently also reduce agricultural production.

Stressed soils can also be slow to regenerate naturally. This regeneration process can sometimes taking years as each season only provides a short window of opportunity to allow soil to recover.

Examples of the invention seek to solve or at least ameliorate one or more disadvantages of previous agricultural practices including reduce or eliminate use of harmful traditional agricultural treatments or reduce costs of agricultural production, as well as to desirably improve increase plant production including crop plants by enhancing soil health condition.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF THE INVENTION

According to the present invention there is provided a composition for treating plants seeds and soils for improvement of soil microbiology populations to facilitate enhanced plant growth wherein the composition comprises at least one bioflavonoid and at least one organic acid.

Preferably, the composition includes at least one wetting agent. More preferably, the at least one wetting agent is a natural plant extract.

The at least one bioflavonoid may be a natural plant extract. Further, the organic acid may be a naturally produced organic acid.

Preferably, the composition is in the form of a liquid. The composition may comprise 0.25 to 4 ml in a topical composition per litre of water or other diluting agent. More preferably, the topical composition is suitable for application to plant foliar. Alternatively, the topical composition is suitable for application as an irrigation additive. The irrigation addictive could be delivered by a drip system or other irrigation method. The composition may also comprise a direct soil additive when combined with a soil biological food source.

In a most preferred embodiment, the composition comprises:
between 10% to 20% (by weight) at least one bioflavonoid; or
between 30% to 60% (by weight) at least one organic acid; and/or
between 10% to 20% (by weight) at least one wetting agent.

The at least one bioflavonoid may be selected from the group including: citrus fruit plant extracts, including grapefruit, lemon, lime, pomelo, orange, tangerine, bitter orange extract.

The at least one organic acid may be selected from the group including: malic acid, citric acid, lactic acid, salicylic acid, caprylic acid, Silicic acid, Ascorbic acid and tartaric acid.

The at least one wetting agent may be selected from the group including: Saponins, glycerine.

The composition may include plant foliar or irrigation treatments including at least one of plant growth regulators, bactericides or fungicides.

### DETAILED DESCRIPTION OF THE INVENTION

Preferred embodiments of the present invention are directed to compositions for the general improvement of agricultural production including enhancing soil health condition and/or increasing beneficial soil microbial populations. The compositions preferably comprises at least one bioflavonoid in combination with at least one organic acid. The compositions may also include at least one wetting agent. Specifically the applicant has found that the soil microbial populations are improved by use of these compositions according to the present invention effecting a natural symbiotic relationship between the plant and soil thereby improving plant yield and growth.

The applicant considers that the treatment of the composition on the foliar of the plant provides the advantage of stimulating production of bioflavonoids and other plant compounds which are needed for the process of secondary metabolism in plants where the plants are not able to adequately produce these compounds due to the effects of abiotic or biotic stress condition. In addition, the application has found that the treatment of plants and roots with the composition improves plant processes centred around bioflavonoid production in the plant. The follow-on effect of this is an improvement in the plants relationship with soil microbiology resulting in a rise in the population of microbes around the roots of the plant.

In a preferred embodiment of the invention, there is a composition which comprises at least one bioflavonoid, at least one organic acid for improvement of seed germination rate and early stage plant development. Preferably the composition includes at least one wetting agent. In particular, it is preferred that the at least one bioflavonoid, the at least one organic acid and/or the at least one wetting agent are natural plant extracts or naturally produced elements.

Preferably, the composition is present in the topical composition at between 0.25 ml to 4 ml per litre of diluting agent such as water. However the dilution can vary, as would be understood by a person skilled in the art, depending on different factors such as soil condition, foliage cover, growth rate, crop type, weather, water used per hectare etc. The topical composition can be applied as a plant foliar spray on the roots, stems or leaves, or as an irrigation additive delivered via a drip system.

The composition improves the relationship with the soil microbes and the plant to provide an ongoing benefit to the plants health. The cycle of healthy soil and healthy plant can be maintained by additional applications through the growing season but single applications have shown an ongoing effect. Preferably, the product is applied to plants during the cool of the day, and preferably not prior to or just subsequent to rain. As the product is taken up by the leaves, it is better, if it is likely to rain within six hours to apply the product at a later time.

Most preferably, for best results, the product can be sprayed in a light mist and the spray be repeated some five days after the first spray. If, after a second spray, there is still signs of the infestation, the spraying can be repeated after a further five days.

The composition advantageously provides a way to regenerate poor soils and invigorate soils under stress conditions. The natural process of soil health regeneration can take years as each season provides a short window of opportunity. With the embodiments of the present invention the time to regenerate a healthy soil is considerable shortened. Ongoing soil health is also maintained throughout a season and onto the next. Healthy soils and crops can sequester far more carbon into the soil which can contribute to reduced CO₂ gases in the atmosphere. Healthy soils and crops provide higher nutritional value and flavour to food.

In a particularly preferred embodiment, the composition comprises:
between 10% to 25% (by weight) at least one bioflavonoid; or
between 30% to 60% (by weight) at least one organic acid; and/or
between 10% to 20% (by weight) at least one wetting agent.

In particular, the at least one bioflavonoid is a citrus agent.

As the composition comprises entirely of natural plant extracts and organic acids there is no toxicity at recommended topical application dilution levels. The naturally extracted components of the compositions may be found on lists, such as the USDA GRAS list which is generally recognised as safe levels for food or dietary supplements. Specifically the safe levels as recommended by the USDA GRAS list are much higher doses than the levels of the composition in a topical application dilution level. Thus the compositions are much more acceptable to consumers who prefer and demand less harmful agricultural additives to those currently used in traditional agricultural methods.

The applicant has discovered that when plants or soil have been treated with said composition, the composition effects noticeable improvement of plant development particularly in new plant varieties which have been selectively bred or which have been genetically modified. This is especially important for food crops and other important plant types.

In a preferred embodiment, the composition is in a liquid form. The composition is able to be easily produced into a topical composition by being diluted with a diluting agent such as water. In a particularly preferred embodiment, the composition is present at between 0.4 to 4m1 when diluted in 1 L of water or other diluting agent.

The Applicant has conducted trials of the composition by applying the composition to a loam soil with medium organic matter for growing grapes under irrigation. Two separate trials were conducted with the soil being treated with the composition being compared with an adjacent batch of soil that was untreated (control). The first batch of results are shown below:

TABLE 1
Control Analysis

| | | | | | | | | Nematode detail | |
|---|---|---|---|---|---|---|---|---|---|
| | | | | | | | | (# per gram or # per mL) | |
| | | | | | | | | Classifed by type and | |
| | | | | | | | Hyphal | identified to genus. | |
| Organism | | | Active Bacterial | Total Bacterial | Active Fungal | Total Fungal | Diameter | (if section is blank, | |
| Biomass Data | | Dry Weight | (μg/g) | (μg/g) | (μg/g) | (μg/g) | (μm) | no nematodes identified.) | |
| Results | | 0.910 | 0.9 [symbol] | 13.8 | 117 | 421 | 4 | Bacterial Feeders | |
| Comments | | Too Dry | Below range | Below range | Above range | In range | | Bacterial Feeder | 0.70 |
| Expected | Low | 0.45 | 1 | 100 | 10 | 200 | | Fungal Feeders | |
| Range | High | 0.55 | 10 | 300 | 25 | [symbol] 00 | | Fungal Feeder | 0.5 [symbol] |
| | | | | | | | | [symbol] | |
| | | | | | | | | [symbol] | 0. [symbol] 2 |
| | | | | | | | | Root Feeders | |
| | | | | | | | | Root Feede [symbol] | 0. [symbol] |

| | | Protozoa (Numbers/g) | | | Total | Mycorrhizal Colonizatoin (%) | |
|---|---|---|---|---|---|---|---|
| | | Flagellates | Amoebae | Ciliates | Nematodes [symbol] g | ENDO | ECTO |
| Results | | 1 [symbol] 2 [symbol] | 1 [symbol] 78 | 0 | 1.98 | 11% | 0% |
| Comments | | Low | Low | Low | Low | Low | Low |
| Expected | Low | 5000 | [symbol] 000 | [symbol] 0 | 10 | 40% | 40% |
| Range | High | | | 100 | 20 | 80% | 80% |

| Organism | | Total Fungal to | Active to Total | Active to Total | Active Fungal | Plant Available N |
|---|---|---|---|---|---|---|
| Biomass Ratios | | Tot. Bacterial | Fungal | Bacterial | to Act. Bacterial | Supply (kg/ [symbol] ) |
| Results | | 30.47 | 0.28 | 0.07 | 118.20 | <28 |
| Comments | | High | High | Low | High | |
| Expected | Low | 2 | 0.1 [symbol] | 0.15 | 1 | |
| Range | High | 5 | 0.2 | 0.2 | 2 | |

[symbol]

indicates data missing or illegible when filed

TABLE 2
Treated Sample Analysis

| | | | | | | | | Nematode detail | |
|---|---|---|---|---|---|---|---|---|---|
| | | | | | | | | (# per gram or # per mL) | |
| | | | | | | | | Classifed by type and | |
| | | | | | | | Hyphal | identified to genus. | |
| Organism | | | Active Bacterial | Total Bacterial | Active Fungal | Total Fungal | Diameter | (if section is blank, | |
| Biomass Data | | Dry Weight | (μg/g) | (μg/g) | (μg/g) | (μg/g) | (μm) | no nematodes identified.) | |
| Results | | 0.880 | 3.05 | [symbol] .35 | 279 | 279 | 4 | Bacterial Feeders | |
| Comments | | Too Dry | In range | Below range | Above range | In range | | Bacterial Feeder | 0.89 |
| Expected | Low | 0.45 | 1 | 100 | 10 | 200 | | Fungal Feeders | |
| Range | High | 0.85 | 10 | 3 [symbol] 0 | 25 | 600 | | Fungal Feeder | 0.59 |
| | | | | | | | | [symbol] | |
| | | | | | | | | [symbol] | 0.07 |
| | | | | | | | | Root Feeders | |
| | | | | | | | | Root Feede [symbol] | 1.04 |

| | | Protozoa (Numbers/g) | | | Total | Mycorrhizal Colonizatoin (%) | |
|---|---|---|---|---|---|---|---|
| | | Flagellates | Amoebae | Ciliates | Nematodes [symbol] g | ENDO | ECTO |
| Results | | 2427 | 0 | 0 | 2.85 | 12% | 0% |
| Comments | | Low | Low | Low | Low | Low | Low |
| Expected | Low | 5000 | 5000 | 50 | 10 | 40% | 40% |
| Range | High | | | 100 | 20 | 80% | 80% |

| Organism | | Total Fungal to | Active to Total | Active to Total | Active Fungal | Plant Available N |
|---|---|---|---|---|---|---|
| Biomass Ratios | | Tot. Bacterial | Fungal | Bacterial | to Act. Bacterial | Supply (kg/ [symbol] ) |
| Results | | 29.88 | 1.00 | 0.33 | [symbol] 1.08 | <28 |
| Comments | | High | High | High | High | |
| Comments | Low | 2 | 0.15 | 0.15 | 1 | |
| Range | High | 5 | 0.2 | 0.2 | 2 | |

[symbol]

indicates data missing or illegible when filed

As can be seen in Table 1 for the Control Sample, the soil has a very high fungal count which was not coming from mycorrhizal fungi but rather saprophytic fungi. Saprophytic fungi break down plant organic matter and the control sample had most of the bacterial and fungal populations present in a dormant form which was not providing nutrients to the grape vines. In comparison, as is shown in the treated sample depicted in TABLE 2, the soil sample treated with the present composition had a very good fungal component and good bacterial activity. It is clear when comparing the two results that the total pools have been activated in the treated sample of Table 2, providing a soil that can increase delivery of nutrients to the plant.

Results of a further trial are detailed below using the same soil samples:

TABLE 3
Control Sample Analysis

| | | | | | | | | Nematode detail |
|---|---|---|---|---|---|---|---|---|
| | | | | | | | | (# per gram or # per mL) |
| | | | | | | | | Classifed by type and |
| | | | | | | | Hyphal | identified to genus. |
| Organism | | | Active Bacterial | Total Bacterial | Active Fungal | Total Fungal | Diameter | (if section is blank, |
| Biomass Data | | Dry Weight | (μg/g) | (μg/g) | (μg/g) | (μg/g) | (μm) | no nematodes identified.) |
| Results | | 0.780 | 39.5 | 3 [symbol] 0 | 3.47 | 328 | 2.75 | |
| Comments | | In Good Range | Above range | Above range | Below range | In range | | |
| Expected | Low | 0.45 | 1 | 100 | 10 | 200 | | |
| Range | Hig | 0.85 | 10 | 300 | 25 | 600 | | |

| | | Protozoa (Numbers/g) | | | Total | Mycorrhizal Colonizatoin (%) | |
|---|---|---|---|---|---|---|---|
| | | Flagellates | Amoebae | Ciliates | Nematodes [symbol] g | ENDO | ECTO |
| Results | | 738 | 547 | 35 | Not Ordered | 35% | 46% |
| Comments | | Low | Low | Low | | Low | Good |
| Expected | Low | 12000 | 12000 | 50 | 10 | 40% | 40% |
| Range | Hig | | | 100 | 20 | 80% | 80% |

| Organism | | Total Fungal to | Active to Total | Active to Total | Active Fungal | Plant Available N |
|---|---|---|---|---|---|---|
| Biomass Ratios | | Tot. Bacterial | Fungal | Bacterial | to Act. Bacterial | Supply (kg/ [symbol] ) |
| Results | | 1.06 | 0.01 | 0.13 | 0.09 | <28 |
| Comments | | Low | Low | Low | Low | |
| Expected | Low | 2 | 0.15 | 0.15 | 1 | |
| Range | Hig | 5 | 0.2 | 0.2 | 2 | |

[symbol]

indicates data missing or illegible when filed

TABLE 4
Treated Sample Analysis - 200 ml of composition

| | | | | | | | | Nematode detail |
|---|---|---|---|---|---|---|---|---|
| | | | | | | | | (# per gram or # per mL) |
| | | | | | | | | Classifed by type and |
| | | | | | | | Hyphal | identified to genus. |
| Organism | | | Active Bacterial | Total Bacterial | Active Fungal | Total Fungal | Diameter | (if section is blank, |
| Biomass Data | | Dry Weight | (μg/g) | (μg/g) | (μg/g) | (μg/g) | (μm) | no nematodes identified.) |
| Results | | 0.780 | [symbol] | 291 | 1. [symbol] | 27 [symbol] | 2.75 | |
| Comments | | In Good Range | Above range | In range | Below range | In range | | |
| Expected | Low | 0.4 [symbol] | 1 | 100 | 10 | 200 | | |
| Range | Hig | 0.85 | 10 | 3 [symbol] | 25 | [symbol] 00 | | |

| | | Protozoa (Numbers/g) | | | Total | Mycorrhizal Colonizatoin (%) | |
|---|---|---|---|---|---|---|---|
| | | Flagellates | Amoebae | Ciliates | Nematodes [symbol] g | ENDO | ECTO |
| Results | | 7344 | 7344 | 543 | Not Ordered | 78% | 4% |
| Comments | | Low | Low | High | | Good | Low |
| Expected | Low | 1200 | 1200 | [symbol] | 10 | 40% | 40% |
| Range | Hig | | | 100 | 20 | 80% | 80% |

| Organism | | Total Fungal to | Active to Total | Active to Total | Active Fungal | Plant Available N |
|---|---|---|---|---|---|---|
| Biomass Ratios | | Tot. Bacterial | Fungal | Bacterial | to Act. Bacterial | Supply (kg/ [symbol] ) |
| Results | | 0.96 | 0.004 | 0.05 | 0.08 | 84. [symbol] 2 |
| Comments | | Low | Low | Low | Low | |
| Expected | Low | 2 | [symbol] 5 | 0.15 | 1 | |
| Range | Hig | 5 | 0.2 | 0.2 | 2 | |

[symbol]

indicates data missing or illegible when filed

Once again, in the control sample, the mycorrhizal colonisation consisted of a combination of Endo and Ecto species at the low ends of the recommended ranges. The Endo Mycorrhiza (VAM) reveals very little vesical formation and few hypha. In comparison, the soil treated with the composition of the present invention had an improved mycorrhizal colonisation, particularly Endo mycorrhizae, which was at a good level. In this sample Endo Mycorrhizae (VAM) revealed many healthy vesical and hyphal formations. Thus, once again, it is clear when comparing the two results that the total pools have been activated in the treated sample of Table 4, providing a soil that can increase delivery of nutrients to the plant.

The applicant has found that this composition for improving soil health can be used on various food crops such as vegetables, fruit and nut trees, turf, and broad acre crops such as canola, soy and wheat.

The at least one bioflavonoid may be selected from the group including: citrus fruit plant extracts, including grapefruit, lemon, lime, pomelo, orange, tangerine, bitter orange extract.

The at least one organic acid may be selected from the group including: malic acid, citric acid, lactic acid, salicylic acid, caprylic acid, Silicic acid, Ascorbic acid and tartaric acid.

The at least one wetting agent may be selected from the group including: Saponins.

In a particularly preferred embodiment, the compositions mentioned above can include other plant foliar or irrigation additives which can provide additional benefits such as plant growth regulators, fungicides, bactericides and the like.

Through-out the specification and claims the word “comprise” and its derivatives is intended to have an inclusive rather than exclusive meaning unless the context requires otherwise.

It will be appreciated by those skilled in the art that many modifications and variations may be made to the methods of the invention described herein without departing from the spirit and scope of the invention.

1. A composition for improvement of soil condition to facilitate enhanced plant growth wherein the composition comprises:
at least one bioflavonoid; and
at least one organic acid.

2. A composition according to claim 1, wherein the composition includes at least one wetting agent.

3. A composition according to claim 2, wherein the at least one wetting agent is a natural plant extract.

4. A composition according to claim 2, wherein the at least one bioflavonoid is a natural plant extract.

5. A composition according to claim 2, wherein the at least one organic acid is naturally produced.

6. A composition according to claim 2 being in the form of a liquid.

7. A composition according to claim 2, wherein the composition comprises 0.25 to 4 ml in a topical composition per litre of water or other diluting agent.

8. A composition according to claim 7, wherein the topical composition is suitable for application to plant foliar including roots, leaves

9. A composition according to claim 7, wherein the topical composition is suitable for application as an irrigation additive.

10. A composition according to claim 2, comprising:
between 10% to 20% (by weight) bioflavonoid; or
between 30% to 60% (by weight) organic acid; and/or
between 10% to 20% (by weight) wetting agent.

11. A composition according to claim 2, comprising:
between 10% to 20% (by weight) bioflavonoid which is a natural plant extract; or
between 30% to 60% (by weight) organic acid which is naturally produced; and/or
between 10% to 20% (by weight) wetting agent which is a natural plant extract.

12. A composition according to claim 2, wherein the at least one bioflavonoid is selected from the group including: citrus fruit plant extracts, including grapefruit, lemon, lime, orange, pomelo, tangerine, bitter orange extract.

13. A composition according to claim 2, wherein the at least one organic acid is selected from the group including: malic acid, citric acid, Silicic acid, Ascorbic acid, lactic acid, salicylic acid, caprylic acid and tartaric acid.

14. A composition according to claim 2, wherein the at least one wetting agent is selected from the group consisting of: Saponins and glycerine.

15. A composition according to claim 2, wherein the composition includes plant foliar or irrigation treatments including at least one of plant growth regulators, bactericides or fungicides.
